(19) United States
(12) Patent Application Publication
(10) Pub. No.: US 2022/0136615 A1
(43) Pub. Date: May 5, 2022

(54) Water Supply Assembly Having A Thermostatic Mixing Assembly

(71) Applicant: Oatey Co., Cleveland, OH (US)

(72) Inventor: Sinit Rin, Rocky River, OH (US)

(21) Appl. No.: 17/517,767

(22) Filed: Nov. 3, 2021

Related U.S. Application Data
(60) Provisional application No. 63/109,508, filed on Nov. 4, 2020.

(51) Int. Cl. F16K 27/04; F16K 11/074; F16K 27/02

(52) U.S. Cl. CPC F16K 27/045; F16K 27/0263; F16K 11/074

(57) ABSTRACT

A water supply assembly includes a supply box and a thermostatic mixing assembly operatively connected to the supply box and located at least partially therein. The thermostatic mixing assembly includes a body having a pair of water supply valves, a mixing chamber, and a pair of water outlet ports. The mixing chamber is fluidly connected to the water supply valves for receiving hot and cold water therefrom and providing tempered water that is transferred to one of the pair of water outlet ports. The water outlet ports are fluidly connectable to a faucet to provide a tempered water supply thereto.

### CROSS-REFERENCE TO RELATED APPLICATION

This application claims benefit to U.S. Provisional Application No. 63/109,508, filed Nov. 4, 2020, the contents of which are incorporated by reference herein.

### TECHNICAL FIELD

The disclosure relates generally to plumbing supply boxes, and more particularly, to water supply boxes providing an output of tempered water.

### BACKGROUND

Plumbing connections for a lavatory or faucet in hospitals, commercial restrooms, and other public restrooms often include complex piping for the delivery of water. As shown in FIG. 1, a typical faucet supply includes hot and cold water lines connected to a hot control valve 1 and a cold control valve 2, respectively, extending from the wall. The hot and cold control valves 1, 2 are then connected to a thermostatic mixing cartridge 3 via solid or flexible pipes. The thermostatic mixing cartridge 3 includes a pair of inlets for receiving the solid or flexible hot/cold water supply pipes as well as a first outlet that receives a flexible cold water pipe for transporting the cold water directly to the faucet and a second outlet that receives a flexible tempered water pipe for transporting tempered water directly to the faucet. The thermostatic mixing cartridge is configured to mix the hot and cold water supplies to produce tempered water that is transferable to the faucet. Some embodiments of the thermostatic mixing cartridge include only a single outlet for transporting only tempered water to a faucet. Such a plumbing system requires ten (10) separate pipe connections 4, which increases the potential for leaks or other issues. The illustrate plumbing system and other similar assemblies are complex and cumbersome. The illustrated plumbing system is also accessible by users, which may allow a user to adjust the hot/cold water supplies, which may result in tempered water that is either too cold or too hot. A need therefore exists for a plumbing system that addresses the complexities of such plumbing systems. A need also exists for a plumbing system that allows for protection of the controls to prevent unintended or unnecessary adjustment of the hot/cold water supplies by users.

### SUMMARY

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

In one aspect of the present invention, a water supply assembly for supplying tempered water to a faucet of a sink is provided. The water supply assembly includes a supply box having a top wall, bottom wall, and opposing side walls extending from a rear wall defining a cavity therewithin. A pair of apertures are formed through the bottom wall of the supply box. The water supply assembly also includes a thermostatic mixing assembly positioned at least partially within the supply box. The thermostatic mixing assembly unit has a body, a pair of supply valves extending from the body for receiving hot and cold water supplies, a cold water outlet port and a tempered water outlet port extending from the body, and a mixing chamber located within the body. The pair of supply valves are fluidly connected to the mixing chamber for transporting hot and cold water to the mixing chamber to generate tempered water therewithin. The mixing chamber is fluidly connected to the tempered water outlet port for transferring the tempered water from the mixing chamber to the tempered water outlet port.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there are shown in the drawings illustrative embodiments of the disclosure. It should be understood, however, that the application is not limited to the precise arrangements and instrumentalities shown. In the drawings:

FIG. 1 is an illustration of a prior art plumbing system for delivering hot and cold water to a faucet.

FIG. 2 is an exemplary embodiment of a water supply assembly.

FIG. 3 is an exploded view of the water supply assembly shown in FIG. 2.

FIG. 4 is a top perspective view of an exemplary embodiment of a supply box.

FIG. 5A is top perspective view of an exemplary embodiment of a thermostatic mixing assembly.

FIG. 5B is a front view of the thermostatic mixing assembly shown in FIG. 5A.

FIG. 6 is a front view of another exemplary embodiment of a thermostatic mixing assembly.

FIG. 7A is another exemplary embodiment of a water supply assembly.

FIG. 7B is a front view of an embodiment of a cover plate connected to a face plate located in a closed position.

FIG. 7C is a top perspective view of the cover plate connected to the face plate of FIG. 7B located in an open position.

FIG. 8 is a front perspective view of yet another exemplary embodiment of a water supply assembly.

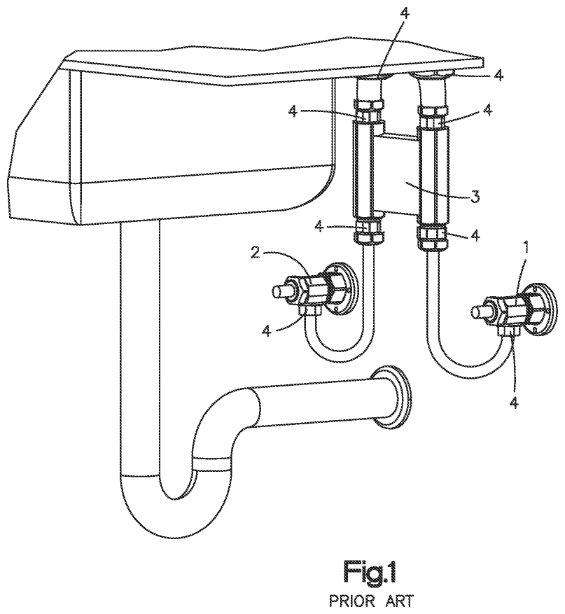

### DETAILED DESCRIPTION

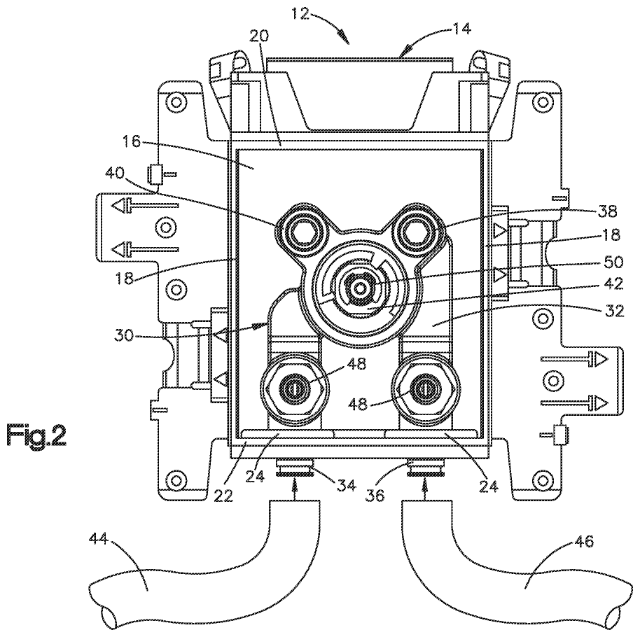

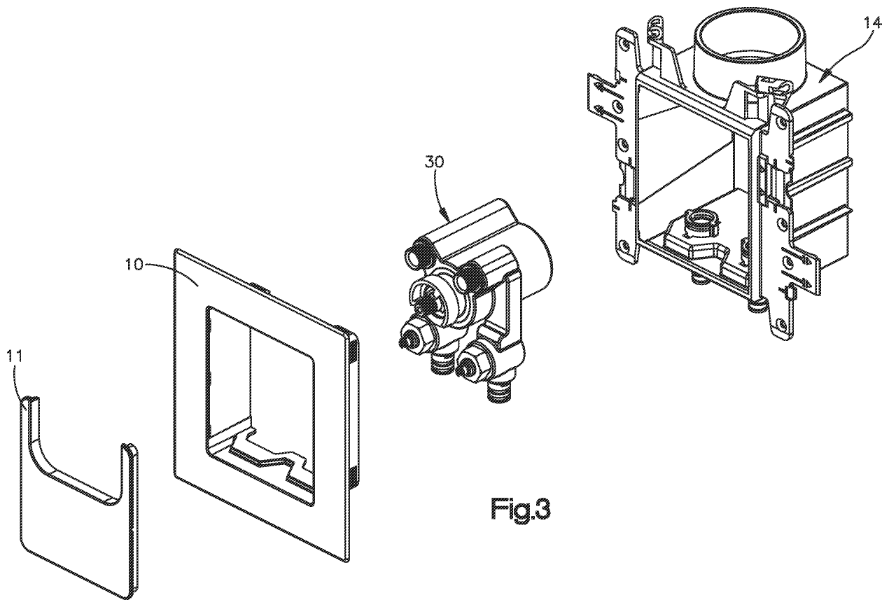

Referring to FIGS. 2-3, an exemplary embodiment of a water supply assembly 12 for providing tempered water to a faucet is shown. The water supply assembly 12 includes a supply box 14 and a thermostatic mixing assembly 30 positioned at least partially within the supply box 14. In some embodiments, the water supply assembly 12 further includes a face plate 10. Other embodiments include the face plate 10 and a cover plate 11. The supply box 14 of the water supply assembly 12 is configured to be mounted in an opening in a wall, wherein the front face of the supply box 14 is substantially flush with the surrounding wall and the remaining portion of the supply box 14 is recessed into the wall. The thermostatic mixing assembly 30 is located within the recessed supply box 14, wherein the thermostatic mixing assembly 30 receives hot and cold water input supplies and produces a tempered water output supply to a faucet (not shown). In other embodiments, the thermostatic mixing assembly 30 provides both a tempered water output supply as well as a cold water output supply that are transferable to a faucet.

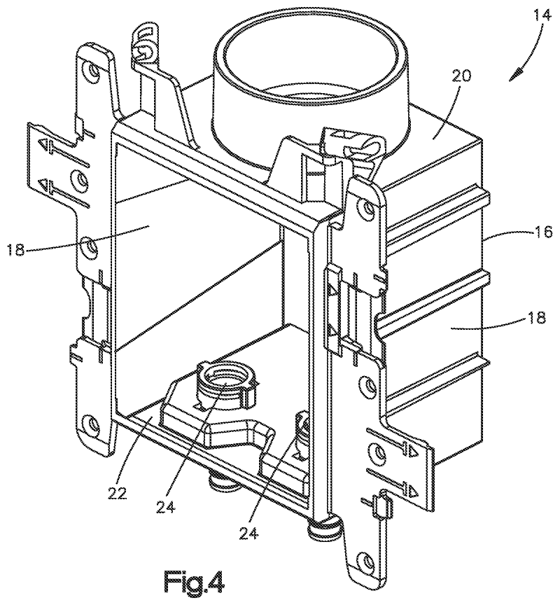

FIGS. 2-4 shown an exemplary embodiment of a supply box 14. In the illustrated embodiment, the supply box 14 includes a rear wall 16, and a pair of opposing side walls 18, a top wall 20, and a bottom wall 22. The side walls 18, top wall 20, and bottom wall 22 all extend from the rear wall 16. The spaced-apart opposing side walls 18 also extending between the top and bottom walls 20, 22. In the illustrated embodiment, the supply box 14 further includes a pair of apertures 24 formed through the bottom wall 22. It should be understood by one having ordinary skill in the art that the supply box 14 can be installed in the upright orientation, as shown in FIG. 3, or an upside-down configuration in which apertures 24 through the bottom wall 22 are directed upwardly. It should be understood by one having ordinary skill in the art that the supply box 14 can be installed horizontally such that the apertures 24 in the bottom wall 22 are directed laterally. In some embodiments, the apertures 24 are formed through the top wall 20. In other embodiments, both the top and bottom walls 20, 22 include a pair of apertures 24 formed therethrough, thereby allowing the supply box 14 to be installed in any vertical orientation to allow the supply box 14 to receive hot and cold water supply lines from above or below. Each aperture 24 of the supply box 14 is configured to receive a supply valve 34, 36 of the thermostatic mixing assembly 30, wherein the supply valves 34, 36 are securable to the supply box 14 to join the thermostatic mixing assembly 30 and the supply box 14 together. The edges of the side walls 18, top wall 20, bottom wall 22, and rear wall 16 define of the supply box 14 define a cavity therein. The edges of the side walls 18, top wall 20, and bottom wall 22 opposite the rear wall 16 define an opening to the cavity. The supply box 14 is configured to be mounted in a recess within a wall, wherein the opening to the supply box 14 is substantially flush with the outwardly-directed surface of the wall. In some embodiments, the face plate 10 is releasably attachable to the supply box 14. The face plate 10 covers or otherwise hides the interface between the supply box 14 and the surrounding wall.

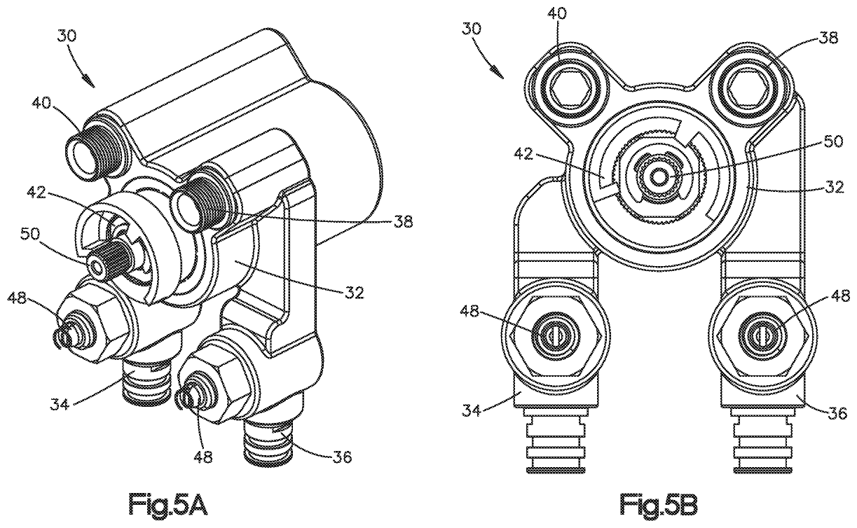

FIGS. 2 and 5A-5B illustrate an example of a thermostatic mixing assembly 30. The thermostatic mixing assembly 30 is configured to receive a supply of hot water and a supply of cold water to provide a tempered water output for a faucet in a bathroom, lavatory, or other setting having a sink with a faucet. In the illustrated embodiment, the thermostatic mixing assembly 30 includes a body 32 having a hot water supply valve 34, a cold water supply valve 36, a cold water outlet port 38, and a tempered water outlet port 40 extending therefrom. The body 32 of the thermostatic mixing assembly 30 further includes a mixing chamber 42 therewithin, wherein hot water and cold water are mixed to generate the tempered water that is output from the thermostatic mixing assembly 30. The hot water supply valve 34 and the cold water supply valve 36 extend downwardly from a lower end of the body 32. The hot and cold water supply valves 34, 36 are configured to be inserted into the apertures 24 of the supply box 14 when positioning the thermostatic mixing assembly 30 therewithin. A hot water supply pipe 44 is attachable to the hot water supply valve 34 for providing hot water to the thermostatic mixing assembly 30, and a cold water supply pipe 46 is attachable to the cold water supply valve 36 for providing cold water to the thermostatic mixing assembly 30. Each of the hot and cold water supply valves 34, 36 can include a connection that is configured to engage varying hot and cold water supply pipe materials 44, 46, respectively, to allow the hot and cold water supply pipes 44, 46 to be easily attachable to the hot and cold water supply valves 34, 36.

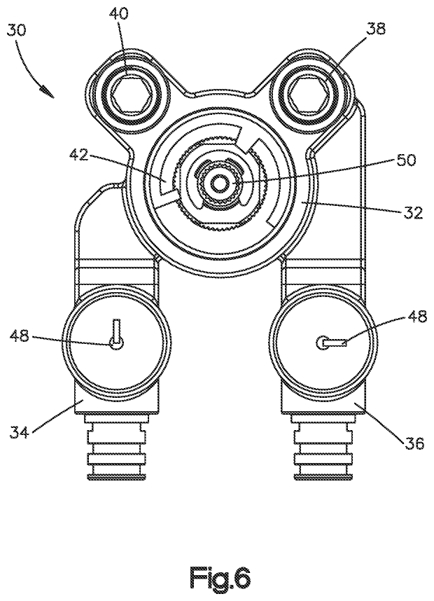

As shown in FIGS. 2 and 5, each of the hot and cold water supply valves 34, 36 includes an integrated shut-off/check-valve mechanism 48 for controlling the on/off flow of water through the valve and preventing water from the mixing chamber 32 to subsequently flow back to hot and cold water supply pipes 44, 46. The shut-off/check-valve mechanisms 48 are configured to be adjustable between a closed position in which each shut-off/check-valve mechanism 48 prevents water from flowing through the respective valve to the mixing chamber 42 and an open position in which each shut-off/check-valve mechanism 48 allows water to freely flow through the respective valve to the mixing chamber 42. It should be understood by one having ordinary skill in the art that the shut-off mechanisms 48 can be infinitely adjustable between the closed position and the open position so as to adjust the relative rate of flow through the respective valve. In the embodiment shown in FIG. 6, the shut-off mechanisms 48 integrally formed with the hot and cold water supply valves 34, 36 are formed as full turn stem valves. In further embodiments, the shut-off mechanisms 48 integrally formed with the hot and cold water supply valves 34, 36 are formed as keyed shut-off mechanisms that require a separate key to allow adjustment thereof. It should be understood by one having ordinary skill in the art that other types of shut-off mechanisms 48 that are selectively adjustable for on/off control (or adjusting the flow rate) of water through the hot and cold water supply valves 34, 36 can be used.

In an embodiment, the hot and cold water supply valves 34, 36 are fluidly connected to the mixing chamber 42, wherein the hot water and a portion of the cold water are mixed. The thermostatic mixing assembly 30 includes a rotatably adjustable mechanism 50 that extends from the body 32 of the thermostatic mixing assembly 30. The adjustment mechanism is operatively connected to the mixing chamber 42, wherein rotation of the adjustment mechanism 50 adjusts the ratio of hot and cold water introduced into the mixing chamber 42. By actuating or otherwise moving the adjustment mechanism 50, the temperature of the tempered water generated within the mixing chamber 42 can be adjusted. The adjustment mechanism 50 is illustrated as a manual adjustment mechanism, but it should be understood by one having ordinary skill in the art that the adjustment mechanism 50 can also be electrically controlled either on-board the thermostatic mixing assembly 30, through a remote control spaced apart from the thermostatic mixing assembly 30, or through a wireless connection with the adjustment mechanism 50. In some embodiments, the hot and water supply valves 34, 36 are fluidly connected to only the mixing chamber 42. In these embodiments, the thermostatic mixing assembly 30 provides only tempered water to a faucet (not shown). In the illustrated embodiment, the hot water supply valve 34 is fluidly connected to only the mixing chamber 42 while the cold water supply valve 36 is fluidly connected to both the mixing chamber 42 and the cold water output port 38. This allows the thermostatic mixing assembly 30 to provide a faucet with cold water separately from tempered water.

As shown in the embodiment of FIGS. 2 and 5, the mixing chamber 42 is fluidly connected to the cold water outlet port 38 and the tempered water outlet port 40. The cold and tempered water outlet ports 38, 40 extend laterally from the body 32 of the thermostatic mixing assembly 30, substantially perpendicular relative to the direction that the hot and cold water supply valves 34, 36 extend from the body 32. In an embodiment, the cold and tempered water outlet ports 38, 40 are externally threaded, whereby one end a water transfer pipe (not shown) can be threadingly engaged with each of the outlet ports 38, 40 while the opposing end of the water transfer pipes is connected to a faucet for transferring cold water and tempered water to the faucet. The mixing chamber 42 is fluidly connected to the tempered water outlet port 40 to provide the tempered water thereto. The cold water outlet port 38 is fluidly connected to the cold water supply valve 36. One end of a first outlet pipe (not shown) is removably attachable to the tempered water outlet port 40, and the opposing end of the first outlet pipe is attachable to an inlet of a faucet for fluidly connecting the tempered water outlet port 40 to the faucet. One end of a second outlet pipe (not shown) is removably attachable to the cold water outlet port 38, and the opposing end of the second outlet pipe is attachable to another inlet of a faucet for fluidly connecting the cold water outlet port 38 to the faucet. In operation, if cold water is not supplied directly to the faucet via the cold water outlet port 38, the cold water outlet port 38 can be capped or otherwise sealed such that cold water cannot be transferred from the thermostatic mixing assembly 30. In another embodiment, the thermostatic mixing assembly 30 does not include a cold water outlet port 38, wherein the only outlet of the thermostatic mixing assembly 30 is the tempered water outlet port 40.

The embodiment of the water supply assembly 12 shown in FIG. 2 includes a supply box 14 having a thermostatic mixing assembly 30 disposed within the cavity thereof, wherein the shut-off mechanisms 48 and the adjustment mechanism 50 are open and exposed. As such, the adjustment of the flow of water to the thermostatic mixing assembly as well as the hot/cold water mixing ratio within the mixing chamber 42 are easily adjustable by a user.

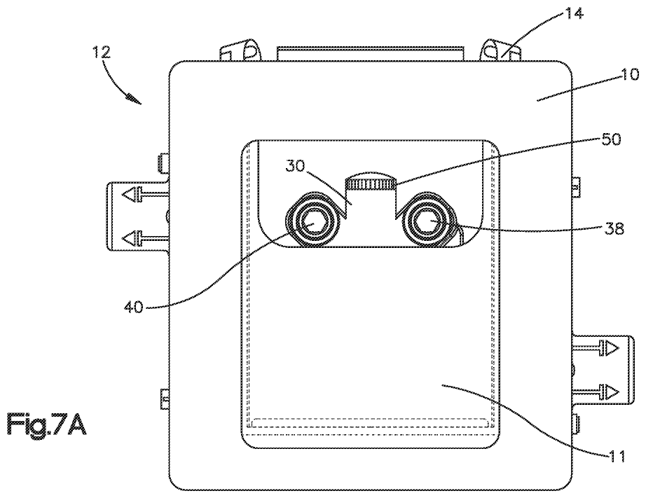

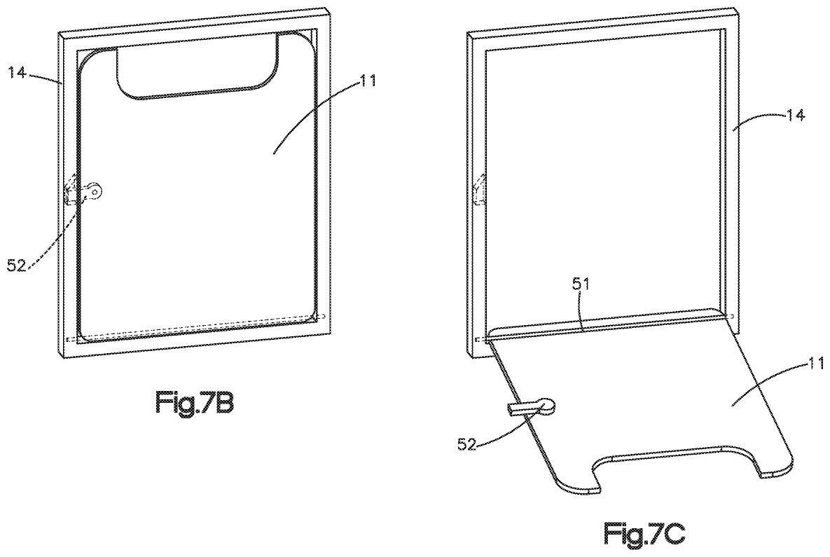

Referring to FIGS. 7A-7C, another exemplary embodiment of a water supply assembly 12 is shown. The water supply assembly 12 includes a supply box 14 and a thermostatic mixing assembly 30 positioned at least partially therewithin. The water supply assembly 12 further includes a cover plate 11 operatively connected to the supply box 14. The cover plate 11 is configured to hide the shut-off mechanisms 48 to prevent a person from shutting off the flow of hot and cold water to the thermostatic mixing assembly 30. In the illustrated embodiment, the cover plate 11 only partially covers the opening to the supply box 14. The cover plate 11 includes a cut-out that allows a portion of the thermostatic mixing assembly 30 to be exposed. The cold and tempered water outlet ports 38, 40 and the adjustment mechanism 50 are positioned within the cut-out of the cover plate 11 such that once the water supply assembly 12 is installed, the ports for connecting the thermostatic mixing assembly 30 to a faucet are easily accessible. The adjustment mechanism 50 is also easily accessible to allow a user to adjust the output temperature of the tempered water within the mixing chamber 42. In other embodiments (not shown), the cover plate 11 covers the entire opening to the supply box 14 such that the adjustment mechanism 50 and the cold and tempered water outlet ports 38, 40 are hidden. As shown in FIGS. 7B-7C, the cover plate 11 is rotatably connected to the supply box 14 by a hinge 52. The hinge 52 allows the cover plate 11 to rotate between a closed or locked position (FIG. 7B) and an open position (FIG. 7C), wherein an operator rotates the cover plate 11 to the open position to gain access to the shut-off mechanisms 48 of the hot and cold water supply valves 34, 36. In some embodiments, the cover plate 11 includes a rotatable locking mechanism 52 having a key slot that requires a loose key to be inserted into the key slot to actuate the locking mechanism 52 between a locked position and an unlocked position.

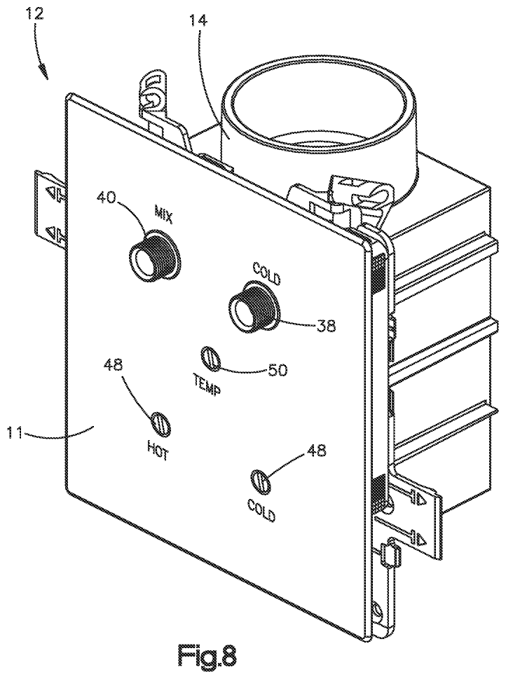

FIG. 8 illustrates yet another exemplary embodiment of a water supply assembly 12. The water supply assembly 12 includes a supply box 14 and a thermostatic mixing assembly 30 (hidden) disposed therein. The water supply assembly 12 further includes a cover plate 11 attached to the supply box 14. The cover plate 11 includes a plurality of apertures formed therethrough, wherein the cold and tempered water outlet ports 38, 40, shut-off mechanisms 48, and the adjustment mechanism 50 either extend through or are accessible through the apertures of the supply box 14. The cover plate 11 is configured to provide an aesthetic cover to the water supply assembly 12.

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A water supply assembly for supplying tempered water to a faucet of a sink, the water supply assembly comprising:
a supply box having a top wall, bottom wall, and opposing side walls extending from a rear wall defining a cavity therewithin, and a pair of apertures are formed through the bottom wall; and
a thermostatic mixing assembly positioned at least partially within the supply box, the thermostatic mixing assembly unit having a body, a pair of supply valves extending from the body for receiving hot and cold water supplies, a cold water outlet port and a tempered water outlet port extending from the body, and a mixing chamber located within the body, wherein the pair of supply valves are fluidly connected to the mixing chamber for transporting hot and cold water to the mixing chamber to generate tempered water therewithin, and wherein the mixing chamber is fluidly connected to the tempered water outlet port for transferring the tempered water from the mixing chamber to the tempered water outlet port.

2. The water supply assembly of claim 1, wherein the pair of supply valves are check/stop valves.

3. The water supply assembly of claim 1, wherein each of the pair of supply valves includes a shut-off mechanism for controlling water flow through the supply valve.

4. The water supply assembly of claim 2, wherein the shut-off mechanisms are quarter-turn valves.

5. The water supply assembly of claim 2, wherein the shut-off mechanisms are keyed shut-off mechanisms.

6. The water supply assembly of claim 1, wherein one of the pair of supply valves is fluidly connected only to the mixing chamber and the other of the pair of supply valves is fluidly connected to the mixing chamber and the second water outlet port.

7. The water supply assembly of claim 1, wherein a rotatable adjustment mechanism extends from the body of the thermostatic mixing assembly, the adjustment mechanism being operatively connected to the mixing chamber, wherein rotation of the adjustment mechanism adjusts the ratio of hot and cold water introduced into the mixing chamber.

8. The water supply assembly of claim 1 further comprising a face plate removably attachable to the supply box.

9. The water supply assembly of claim 1 further comprising a cover plate removably attachable to the supply box.

10. The water supply assembly of claim 1 further comprising a face plate operatively connected to the supply box, wherein the face plate is rotatable between a locked position and an open position.
